(19) United States
(12) Patent Application Publication
(10) Pub. No.: US 2020/0311814 A1
(43) Pub. Date: Oct. 1, 2020

(54) Equity Market Timing & Allocation System

(71) Applicants: Nicholas Ventimiglio, San Ramon, CA (US); Joshua Beal, Bellville, OH (US); Eddy Frank Fotsing Kamboh, Montreal (CA); Christopher Vincent Domino, Chicago, IL (US)

(72) Inventors: Nicholas Ventimiglio, San Ramon, CA (US); Joshua Beal, Bellville, OH (US); Eddy Frank Fotsing Kamboh, Montreal (CA); Christopher Vincent Domino, Chicago, IL (US)

(73) Assignee: Tradewrangler, San Ramon, CA (US)

(21) Appl. No.: 16/363,216

(22) Filed: Mar. 25, 2019

(51) Int. Cl. G06Q 40/06; G06Q 30/02; G06F 17/18

(52) U.S. Cl. CPC G06Q 40/06; G06F 17/18; G06Q 30/0201

(57) ABSTRACT

A system for assessing market risk and for guiding a user in equity market investing uses a network connected server, software executing from a non-transitory medium at the server providing interactive interfaces for a user connected to the server via a browser link, and a plurality of data repositories coupled to the server. The interactive interfaces provide a determination of systematic risk as a single factor for aiding the user in making investment decisions, provide more detailed and supportive allocation recommendations that quantitatively account for both systematic and diversifiable risk, and provide timely alerts and instructions to the user based on changes in Market Risk in an effort to optimize the user's portfolio performance over time.

### BACKGROUND OF THE INVENTION

### 1. Field of the Invention

The invention described herein is in the technical area of investment portfolio management.

### 2. Description of Related Art

While there are several existing processes and software applications in the conventional art which help an investor manage a portfolio, most conventional art focuses on a particular model known in the art as the Efficient Markets Model. This model assumes markets are efficiently priced at all times and by extension, that the optimal investment strategy is to remain continuously invested for the investor's entire investing period. Therefore, currently available systems only assist an investor with solutions around unsystematic risk or what might be called diversifiable risk.

Market risk is the possibility of an investor experiencing losses due to factors that affect the aggregate performance of the financial markets in which the investor is involved. Market risk, also called systematic risk in the art, cannot be eliminated through diversification, though it can be hedged against. The level of Market Risk imposed on investors varies over time; leading to fluctuations in portfolio volatility. It has been demonstrated that this volatility impacts the compounded return the investor inevitably receives over his/her time horizon. Furthermore, it has been shown that heightened volatility during the initial years of distribution for a retirement income generating portfolio can negatively impact its long-term success. Most importantly, it has been confirmed that diversification may not work well when correlations between asset classes run high. In sum, there is clear evidence of market dynamics which present a case for an actively-managed portfolio strategy as an alternative to the more commonly used passive approach to investing. As a result, there is a demonstrable need for tools and applications which assist both retail and professional investors in constructing a sound and dynamic active strategy that accounts for both unsystematic and systematic risk.

There are currently no known systems available to investors that attempt to measure market risk; or the investment risk associated with events which affect aggregate outcomes, such as liquidity imbalances or fluctuations in economic resources and activity. There is a clear bias amongst current investment applications towards only assisting investors with the diversifiable risk of investing.

Therefore, what is clearly needed is a system by which an investor can receive a confident measurement of a current level of market risk and which can actively adjust an investor's portfolio to mitigate and reduce negative impact of systematic risk on long term returns of a portfolio.

### BRIEF SUMMARY OF THE INVENTION

In one embodiment of the invention a system for assessing market risk and for guiding a user in equity market investing is provided, comprising a network connected server, software executing from a non-transitory medium at the server providing interactive interfaces for a user connected to the server via a browser link, and a plurality of data repositories coupled to the server. The interactive interfaces provide a determination of systematic risk as a single factor for aiding the user in making investment decisions, provide more detailed and supportive allocation recommendations that quantitatively account for both systematic and diversifiable risk, and provide timely alerts and instructions to the user based on changes in Market Risk while monitoring the user's portfolio performance over time.

In one embodiment the system constructs a single factor trading algorithm based on market price influences, in real time, determining fluctuations in systematic risk within the market. Also, in one embodiment the user is enabled to adjust criteria for assessing the efficacy of each single factor trading algorithm based on a pool of statistical validation factors which minimize the impact of data-snooping and over-fitting. Also, in one embodiment the system further comprises diversification instructions that are personally augmented to fit the user's risk profile and time horizon. And in one embodiment one of the alerts reports changes in a level of systematic risk in the market.

In one embodiment the system further actively manages the user's investment portfolio and executes portfolio adjustments and investment trades automatically on behalf of the user. Also, in one embodiment the system monitors and reports changes in the relationship or correlation of market factors to market prices over time.

In another aspect of the invention a method for assessing systematic market risk is provided, comprising steps of choosing from a plurality of single factor algorithms statistically validated to influence market risk, or risk that effect aggregate outcomes within an equity market, combining a plurality of single factor algorithms into a Wrangle, being a multivariate assessment engine, and using the Wrangle to make decisions on a level of market exposure an investor should have at a given time based on a current level of market risk determined by the Wrangle.

In one embodiment the method further comprises setting a market exposure measurement in the Wrangle as a limiting condition within a Harry Markowitz Mean Variance Optimization (MVO) process for quantitatively diversifying a portfolio of marketable assets, adjusting the MVO process for a unique risk tolerance and a time horizon to personalize the output recommendations, reporting changes to a Capital Asset Proportion and Allocation Recommendations as they occur, and implementing Allocation Recommendation changes by automatically adjusting the portfolio composition and placing investment trades on behalf of the user.

### BRIEF DESCRIPTION OF THE SEVERAL VIEWS OF THE DRAWINGS

FIG. 1 is a block diagram representing a process in one embodiment of the invention.

FIG. 2 is an architectural diagram mapping software elements and interconnections in an embodiment of the invention.

FIG. 3 is a flow chart illustrating a Signal Construction Process in an embodiment of the invention.

FIG. 4 is a flow chart illustrating a Validation Process in an embodiment of the invention.

FIG. 5 is a flow chart illustrating a Signal Selection Process in an embodiment of the invention.

FIG. 6 is a flow chart illustrating a Wrangle Composition Process in an embodiment of the invention.

FIG. 7 is a flow chart illustrating a CAP Production Process in an embodiment of the invention.

FIG. 8 is a flow chart illustrating an Asset Allocation Engine in an embodiment of the invention.

FIG. 9 is a flow chart illustrating a Service Production Process in an embodiment of the invention.

FIG. 10 is an illustration of a Wrangle Meter user interface in an embodiment of the invention.

FIG. 11A is an illustration of a User Dashboard/Overview Tab interface in an embodiment of the invention.

FIG. 11B is an illustration of a user interface showing performance over time for an account in an embodiment of the invention.

FIG. 11C is another illustration of a user interface showing performance over time for an account in an embodiment of the invention.

FIG. 11D is another illustration of a user interface showing performance over time for an account in an embodiment of the invention.

FIG. 11E yet another illustration of a user interface showing performance over time for an account in an embodiment of the invention.

FIG. 11F is an illustration of a user interface showing performance and risk analysis in an embodiment of the invention.

FIG. 11G is another illustration of a user interface showing performance and risk analysis in an embodiment of the invention.

FIG. 11H is yet another illustration of a user interface showing performance and risk analysis in an embodiment of the invention.

FIG. 12 is an illustration of a user interface showing Weekly Email Alerts a user receives in an embodiment of the invention.

### DETAILED DESCRIPTION OF THE INVENTION

The invention in one embodiment provides a unique market timing and asset allocation engine for investors and investment professionals. A new and innovative process is provided for monitoring and assessing systematic risk, also termed market risk, as a primary parameter for constructing and diversifying a portfolio of equity investments. The invention is described in enabling detail in the following examples, which may represent more than one embodiment of the present invention.

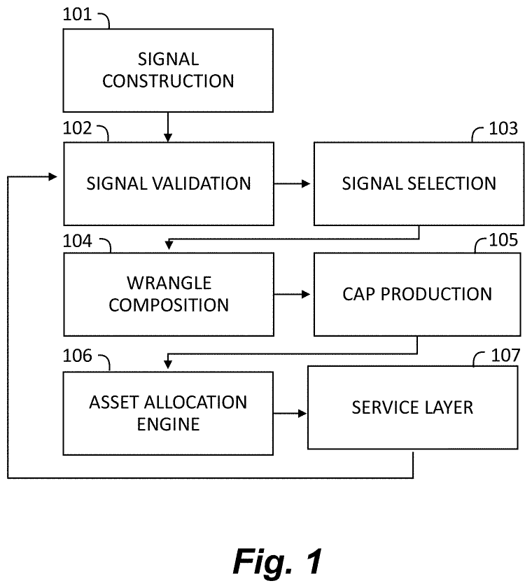

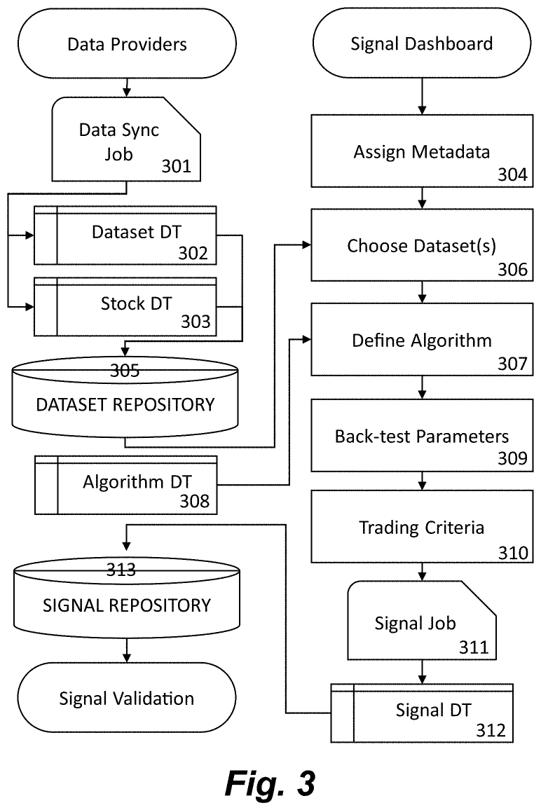

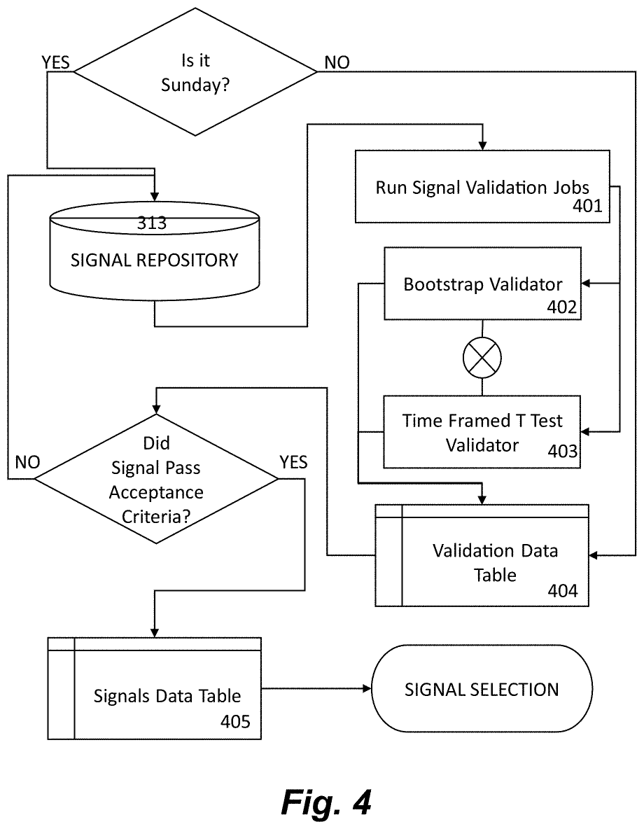

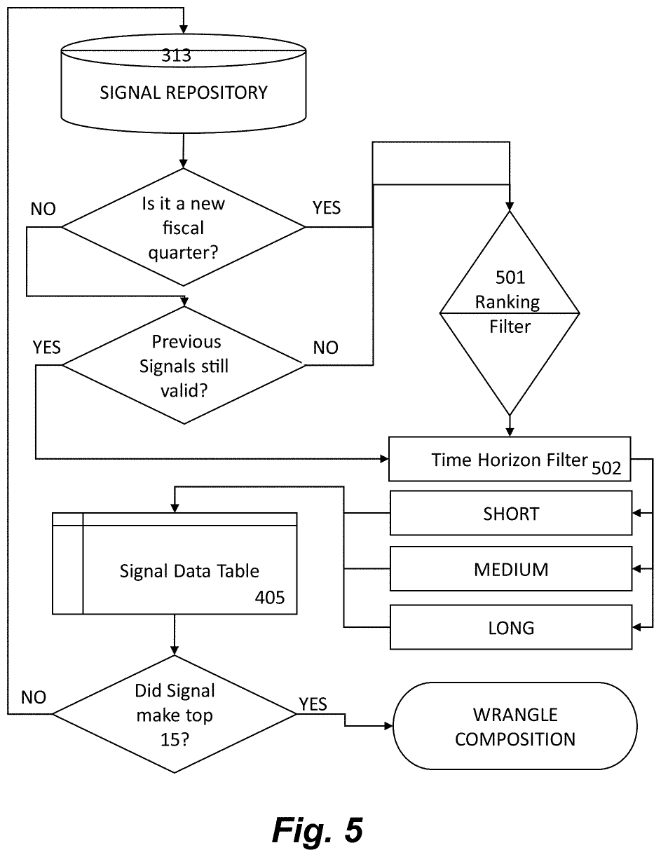

FIG. 1 is a block diagram representing one embodiment of the invention and constituent procedures. A first procedure in the system is a Signal Construction Process 101. This process is further detailed in FIG. 3. A Signal is defined as a trading algorithm applied to a specific time series dataset, or combination of datasets, which may be utilized to make market timing decisions. Efficacy of a Signal is first identified through a back-testing process involved in Signal Construction step 101. Once a Signal is deemed historically effective, it is passed on to Signal Validation step 102. Signal Validation Process 102 reviews and assesses each Signal to ensure performance is statistically significant. This process is further detailed in FIG. 4. Once all Signals available to the system have been either validated or invalidated, the validated signals are segregated for further scrutiny by a Signal Selection Process 103. A purpose of this process is to procure a top segment of validated Signals. This process is further detailed in FIG. 5.

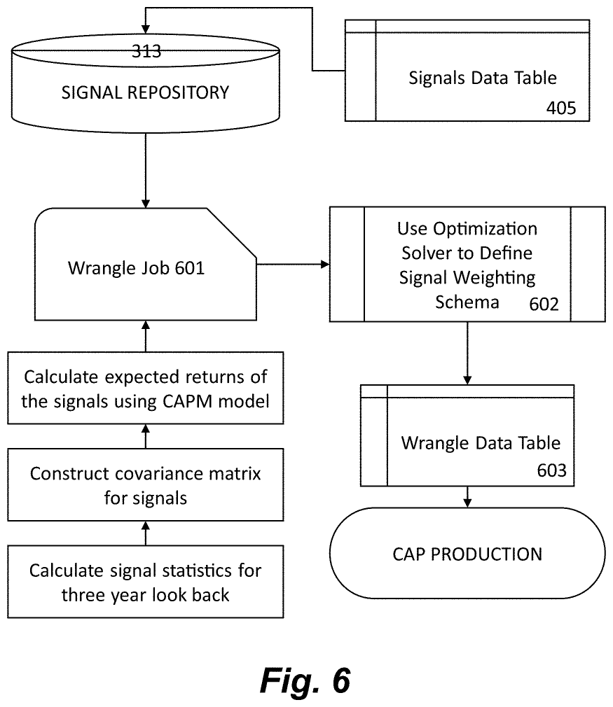

Once the top Signals have been selected through step 103, they are passed into a Wrangle Composition Process 104. A Wrangle is defined herein as a collection of Signals combined to create an expert timing system. Wrangle Composition process 104 is further detailed in FIG. 6. Once a Wrangle has been constructed it may be used to assess an optimal level of market exposure, being a proportion of an investor's assets that should be held in equities given a currently assessed level of Market Risk present.

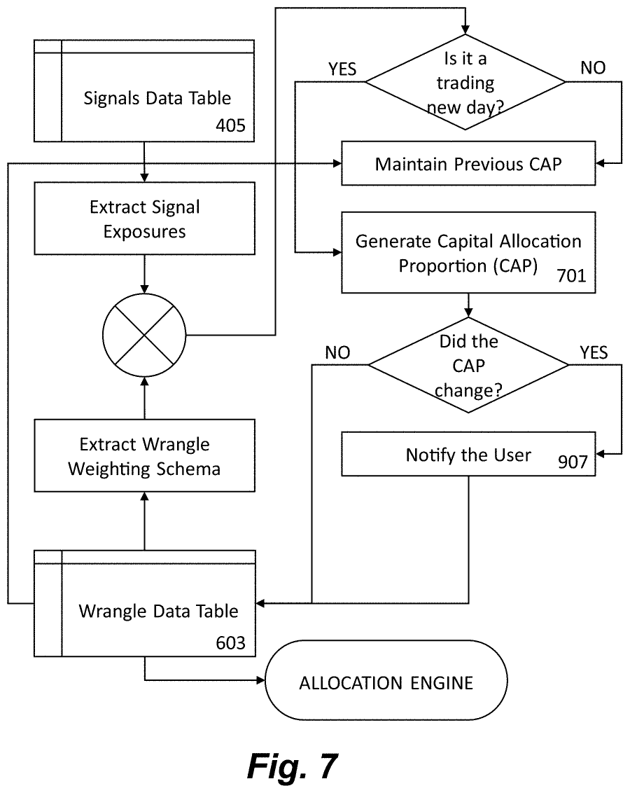

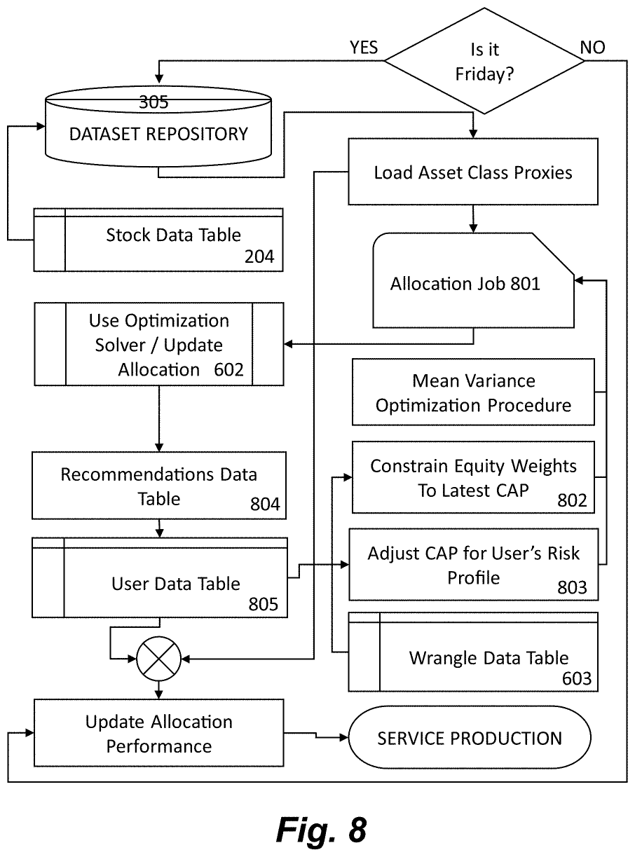

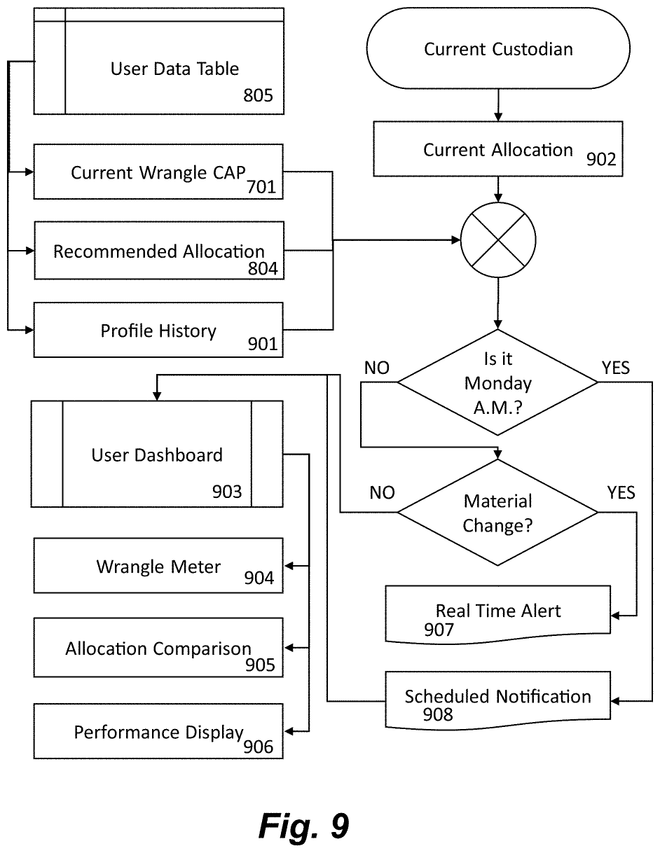

The inventor defines the Wrangle's output as a Capital Allocation Proportion, or CAP for short). A CAP Production process 105 is a next sequential procedure in the process. This process is further detailed in FIG. 7. After a CAP is produced, it is passed to an Asset Allocation Engine 106. Asset Allocation Engine 106 is an augmented Mean Variance Optimization (MVO) process whereby CAP 105 is assigned as a constraint within the optimization process. Asset Allocation Engine 106 is further detailed with reference to FIG. 8. After Engine 106 generates a recommended asset allocation model, Service Production 107 can commence. The invention's Service Production process creates a demonstrable value for the user. This process is further detailed in reference to FIG. 9.

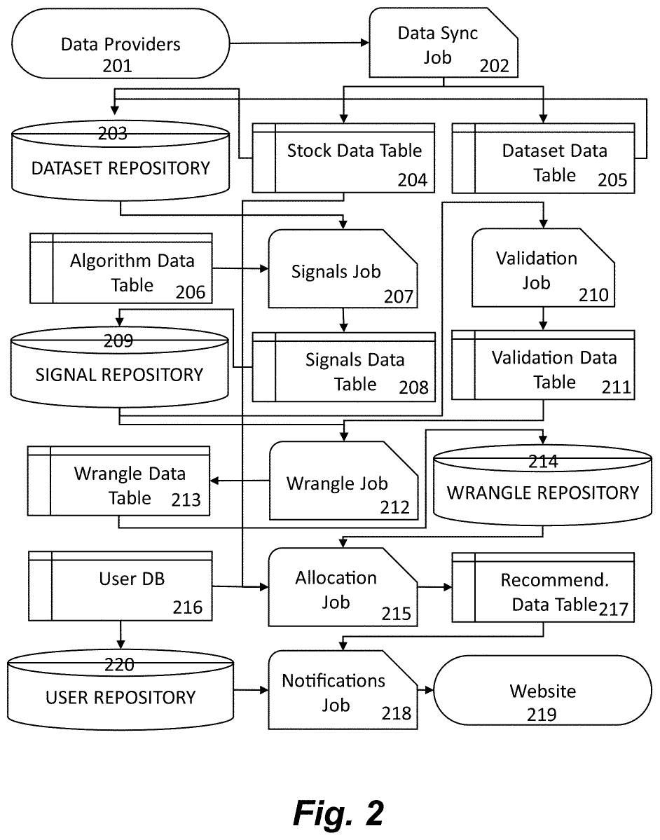

FIG. 2 is an architectural diagram mapping software elements and interconnections that operate in one embodiment of the in the invention. It should be noted that the software architecture diagram is simplified to emphasize function and to clearly communicate the nature of the invention in one embodiment of the invention. Within this framework, any storage of information is referred to as a data table, any management or retrieval of information as a repository, and any collation, sorting, augmenting, or calculating process as a job. Data Sync Job 202 pulls economic, fundamental, sentimental, and technical datasets from a plurality of external sources labeled as the Data Providers 201 within the figure drawing. These datasets are primarily stored in Dataset Data Table 205, with an exception of stock related data, such as prices and trading volume, which is stored in a segregated table known as Stock Data Table 204. Datasets are managed by Dataset Repository 203 until they are pulled by various jobs within the invention.

In this example Signals Job 211 pulls stored data from Data Tables 204 and 205 in conjunction with Algorithm Database 206 to produce (and update) Signals of the system, which are subsequently stored in Signal Data Table 208. As with raw datasets, Signals are managed by their own Signal Repository 209. On a recurring basis, Signals from Repository 209 are pulled by Validation Job 210 to perform continuous statistical testing, which verifies efficacy of each Signal. Test results are stored in Validation Data Table 211. Signals that fail validation based on configurable acceptance criteria for each validator are marked as unapproved. These results are also stored in Table 211. Wrangle Job 212 ingests Signals provided from Repository 209 based on approval results stored in Validation Table 211.

Detailed composition instructions for each Wrangle are stored in Wrangle Data Table 213 and managed by Wrangle Repository 214. Allocation Job 215 combines appropriate Wrangle output from Wrangle Data Table 213 with specified asset class proxies provided by Stock Data Table 204. Results of the allocation job are adjusted for each user based on a Risk Profile (described in FIG. 8) to produce personalized allocation recommendations. A Risk Profile score is stored in the User Data Table 216 while the recommendations from the allocation job are stored in Recommendations Data Table 217. Data from Table 217 and personalized information provided by User Data Table 216 (care of the User Repository 220) are leveraged by Notifications Job 218 to produce adjustment instructions. Notifications Job 218 is also responsible for tracking the history of those adjustments and unfolding performance that occurs as the user continues the service. These outputs are demonstrated through commercial Website 219.

FIG. 3 is a flow chart illustrating a Signal Construction Process in one embodiment of the invention. The inventor defines a Signal as a function of a given algorithm together with a process (time-series data set). Each process (or data set) has a given time frequency by which new data points are released. Each Signal checks daily for updates to its respective process. All Signals check for new data daily regardless of the process's publishing frequency. In this way, updates to the data is captured and pushed through the algorithm as quickly as possible. When new data becomes available it is ingested by the algorithm and a new level of exposure is output. The process begins with the Data Sync Job 301 ingesting data from a myriad of external sources. Once data is received and formatted for alignment in the system, each procured dataset is stored in either the Dataset Data Table 302 or the Stock Data Table 303. Stock-related data 303, such as price and trading volume history, is stored separately, since it is called by several jobs independently throughout the processing cycle.

In one embodiment a user or administrator begins constructing a Signal via a dashboard user interface on the website. A first step in the construction process is assigning Metadata 304. Once a Signal has descriptively been defined, the creator can choose which Dataset(s) 306 to use by implementing a query which calls the Dataset Repository 305. After the appropriate dataset(s) is/are chosen, the creator defines an Algorithm 307 (selected from stored formulas in the Algorithm Data Table 308.) Following this, the creator may choose Back-testing Parameters 309 which are used in defining a historical performance back-test of the Signal. Lastly, the creator may define exposure rules or Trading Criteria 310 and then the Signal Job 311 produces a Signal. All constructed Signals are stored in the Signal Data Table 312 until they are called in the Signal Repository 313 by a constituent process of the invention such as Signal Validation.

FIG. 4 is a flow chart illustrating a Signal Validation Process in one embodiment of the invention. The Signal Validation Process may be run weekly on Sundays. It should be noted that this frequency and weekday is not limiting to the spirit and scope of the invention. It is merely the current parameter of the system and may be changed at some future date. If the current day does not match the processing day (currently Sunday) criteria, then the previous Validation job results persist. If the current day does match the processing day (currently Sunday) criteria, then the Signal Repository 313 is queried for all available Signals. These Signals are collected and presented to the Validation Job coordination component 401.

In one embodiment each Signal is individually passed through a series of statistical validation tests. Also, in one embodiment the system utilizes a Bootstrap Validator 402 and a Time Framed T Test Validator 403. Given Signal X, a Bootstrap Validator 402 approximates the probability that an investor would outperform a passive strategy by implementing X, provided the investor applied strategy X for at least 5 years. This validator is dependent on a benchmark and a metric selected. The Time Framed T Test Validator 403 is a hypothesis test that infers the average outperformance of Signal X with respect to the passive strategy against an entire universe of tradable assets over a given time period. This validator is dependent on a performance metric and time period. Time Framed T-Test Validator 403 implicitly tests for overfitting and outperformance due to data snooping since the test is performed over a random sample of assets in the universe, in one embodiment.

It should be noted that the validation processes chosen at present represent only two of many possible statistical validation techniques which can be utilized to prevent overfitting and data snooping from degrading the efficacy and accuracy of the system's Signals. The tests chosen are not limiting to the scope of the invention, but merely preferable. These tests are merely the current validators within the system and may be changed at some future date. The results of tests 402 and 403 are stored in the Validation Data Table 404.

In this example, each Signal that passes the threshold values for each Validator 402 and 403 is then sent forward and recorded in the Signals Data Table 405 to be employed within the Signal Selection Process that is described below with reference to FIG. 5.

FIG. 5 is flow chart illustrating a Signal Selection Process in one embodiment of the invention. The Signal Selection Process in this example runs at least quarterly. but may run any time a previously validated Signal 404 subsequently fails its weekly validation testing referenced in FIG. 4. It should be noted that the quarterly frequency for the Signal Selection Process is preferable, and not limiting to the scope of the invention. If either the current date is a new fiscal quarter, or a previously approved Signal fails its validation process, then all approved Signals may be passed from the Signal Repository 313 to a proprietary Blended Filter 501. Blended Filter 501 analyzes the efficacy of each Signals against a wide range of traditional investment metrics including, but not limited to, cumulative return, standard deviation, Beta (to a corresponding benchmark investment), Alpha (to a corresponding benchmark investment), Sharpe ratio, Upside Capture, and Downside Capture. These metrics may be reviewed in aggregate through a proprietary weighting schema determined by the inventor. It should be noted that the metrics chosen at present represent only a few of many possible investment metrics which can be utilized to assess the efficacy of the system's Signals.

The metrics chosen are only material to the spirit and scope of the invention insofar as they allow the invention to rank a Signal against the known universe of available Signals in the Repository 313. These metrics may be changed at some future date. Once the Blended Filter 501 has ranked the Signals, they are then grouped by the Time Horizon Filter 502. Filter 502 categorizes each of the approved Signals by several sensitivity metrics including a Signal's volatility and data set publication frequency (i.e. Intraday, Daily, weekly, monthly, quarterly, semi-annually, annually) to ascertain which Signals are appropriate for a short-term, medium term, and/or long-term investor.

It should be noted that the metrics chosen at present in the Time Horizon Filter 502 represent only a few of many possible performance metrics which can be utilized to assess the appropriateness of the system's Signals for an investor's specific time horizon. The metrics chosen are only material to the spirit and scope of the invention insofar as they align a group of Signal's to an appropriate time horizon. These metrics may be changed at some future date. Once Time Horizon Filter 502 subdivides the approved Signals by their respective time horizon characteristics, the results are recorded and assigned within the Signals Data Table 405 until they are called by the Wrangle Composition Process described below with reference to FIG. 6.

FIG. 6 is a flow chart illustrating a Wrangle Composition Process in an embodiment of the invention. During the Wrangle Composition Process, a modified Mean Variance Optimization (MVO) protocol is executed to produce an optimal Signal mix that will become the Wrangle. Historical data for each of the Signals maintained in the Signal Data Table 405 is pulled from the Signal Repository 313. This data is to run Wrangle Job 601.

A first operation run by Job 601 is computing return and standard deviation statistics for a three-year look-back period from the date the optimization protocol is running. Secondly, a covariance matrix from the constituent Signals is constructed. The resulting statistics and matrix are utilized within a Capital Asset Pricing Model (CAPM) to produce return and volatility parameters for an investment strategy based on a weighting of the Signals. The weighting schema governs and defines the Wrangle (defined by the inventor as a collection of Signals combined to create an expert timing system). This schema is defined and optimized via an Optimization Solver 602. Once a Wrangle is constructed it is recorded and maintained in Wrangle Data Table 603. It should be noted that the three year look back period for the modified MVO process is not limiting to the scope of the invention. It is merely the current parameter of the system and may be changed at some future date.

FIG. 7 is a flow chart illustrating a CAP Production Process in one embodiment of the invention. Capital Allocation Proportion (CAP) 701 determines a proportion of broad market exposure an investor should have at a given time based upon the level of systematic risk ascertained by the Wrangle. CAP 701 is produced by combining Signal exposures from Signals Data Table 405 and weighting schema identified in the Wrangle Data Table 603 for a respective Wrangle.

Each subsequent trading day CAP 701 is passed to an Asset Allocation Engine described below with reference to FIG. 7. If CAP 701 materially changes from the previous day, the user is immediately notified via email or SMS, depending on user preference. If CAP 701 did not materially change, no notification is sent before CAP 701 is recorded and preserved in Wrangle Data Table 603.

FIG. 8 is a flow chart illustrating an Asset Allocation Engine in an embodiment of the invention. At the end of each week (currently assigned to Friday), a recommended portfolio allocation may be generated for the user. This recommendation is derived from a second modified Mean Variance Optimization process executed by the system. At present, asset class proxies pulled from Stock Data Table 205 are utilized as assets to be allocated by the process. Future iterations of this invention may include an option for the user to further define the assets available to the portfolio by choosing from an external universe of assets accessible through an outside third party, or by manually defining a custom asset through a tailored interface. It should be noted that so long as there is a definable correlation to equity market assets, the type of assets allocated by the process are not limiting to the scope of this invention. Assets and asset classes may deviate and/or may be provided by multiple sources in alternative embodiments.

Allocation Job 801 begins by querying Dataset Repository 305 for appropriate asset proxies to allocate. Stock Data Table 205 provides Repository 305 with asset histories for the preceding three years for each of the proxies as of the current optimization date. Allocation Job 801 uses these histories to produce return statistics, standard deviation statistics, and correlation matrix. Subsequently, this data is employed in a CAPM process which produces expected returns of each asset proxy. These expected returns are passed in conjunction with the CAP 701, stored in Wrangle Data Table 603, to Optimization Solver 602 which will produce a recommended allocation.

CAP 701 acts as a limiting parameter 803 whereby all equity market asset class weights defined by Solver 602 must sum to CAP 701. In defining the recommended asset allocation, Solver 602 will identify weights of each equity asset proxy beholden to CAP constraint 802, as well as the weights of non-equity asset proxies comprising the portfolio. Before the allocation is produced, Solver 602 is further constrained by a Risk Profile Setting 803, stored in the User Data Table 805. This Risk Profile Setting 803 is calibrated based on a scored questionnaire completed during configuration for a new user. It should be noted that the three-year look-back period for this modified MVO process is not limiting to the scope of the invention, it is merely a configurable parameter of the system and may be changed at some future date. All Cap 701 adjusted allocation updates are stored in Recommendations Data Table 804 to preserve the system's recommendation history.

FIG. 9 is a flow chart illustrating a Service Production process in an embodiment of the invention. Upon commencement of the service by a user, the system will leverage Wrangle 603 to produce a CAP 701 daily. Also as previously described, the latest CAP 701 will be used every Friday in conjunction with the user's Risk Profile Setting 803 to produce personalized Allocation Recommendations 804, in one embodiment. History 901 of these Recommendations 804 is applied to the user's initial investment portfolio balance to illustrate performance impact that these Recommendations 804 have over time. This performance line is compared to the user's actual portfolio performance, taken from Current Allocation 902 by a digital handshake between the system of the invention and the user's current investment custodian on Performance Display 906.

Additionally, the user can track a large number of benchmarks against both the illustrated performance from history 901 of recommendations 804 and their actual portfolio performance 902 through Performance Display 906. All of this information is interfaced to the user through User Dashboard 903. Along with Performance Display 906, User Dashboard 903 provides a dynamic view of the Wrangle's current CAP 701 through Wrangle Meter 904, which is described more fully below. Third, the user is provided with a Comparison 905 of the most recent Recommended Allocation 804 to their Current Portfolio Composition 902.

Recommended Allocation 804 is provided in a second, more verbal display to ensure that guidance provided by the CAP system is clear to the user. In Conjunction with User Dashboard 903, the system also provides email and SMS-based notifications which are both sent in Real Time 907 as events occur as well as on a Scheduled Recurring Basis 908. The types of alerts the user may receive may include changes to Wrangle 603, changes to exposure of Signals 405 in Wrangle 603, changes to current CAP 701, changes to their current allocation recommendation 804, and changes in user's account value 906. Other embodiments of the invention may include other types of alerts as the inventor responds to the needs of its user base.

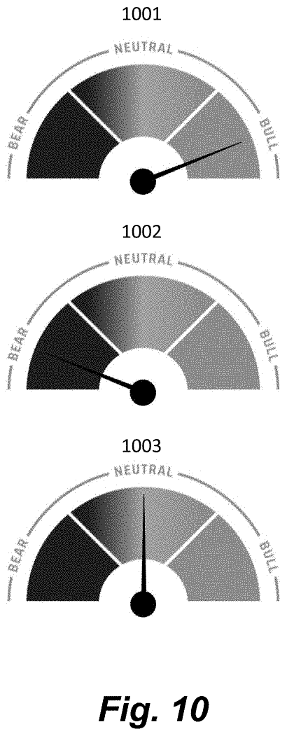

FIG. 10 is an example of a User Interface depicting a Wrangle Meter of the User Dashboard/Wrangle Meter. The Wrangle Meter is an example of how the CAP system demonstrates output measurement of systematic risk in the current equity market. It is important to note that this is only one iteration of an output element by which the invention can demonstrate CAP 701 to the user. Meter 1001 displays a view of the Wrangle Meter when CAP 701 is favorable for investment or “Bullish”. Meter 1002 displays a view of the Wrangle Meter when CAP 701 is unfavorable for investment or “Bearish”. Meter 1003 displays a view of the Wrangle Meter when CAP 701 is cautious towards investment or “Neutral”. CAP 701 reading will fluctuate between 0 and 100 as a percent of exposure, but the Wrangle Meter will migrate between these three states visually. In an alternative embodiment, the Wrangle Meter acts much more dynamically; exhibiting all possible readings rounded to the nearest 1% between 0% and 100% market exposure.

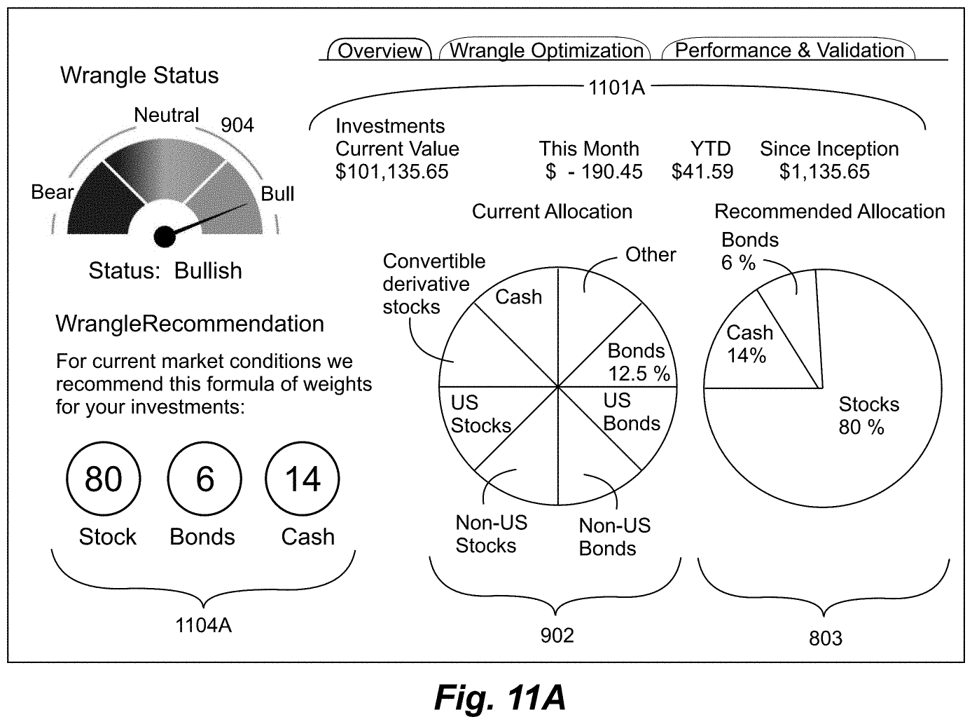

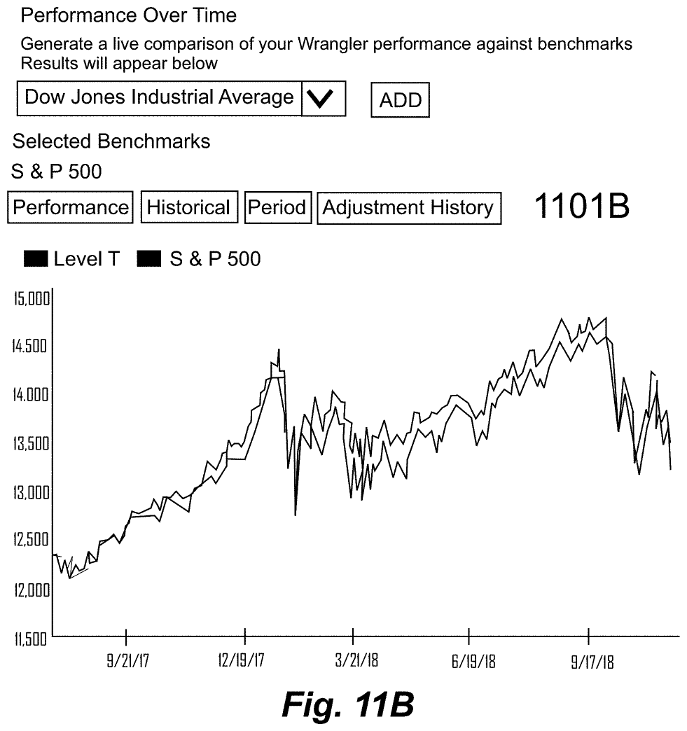

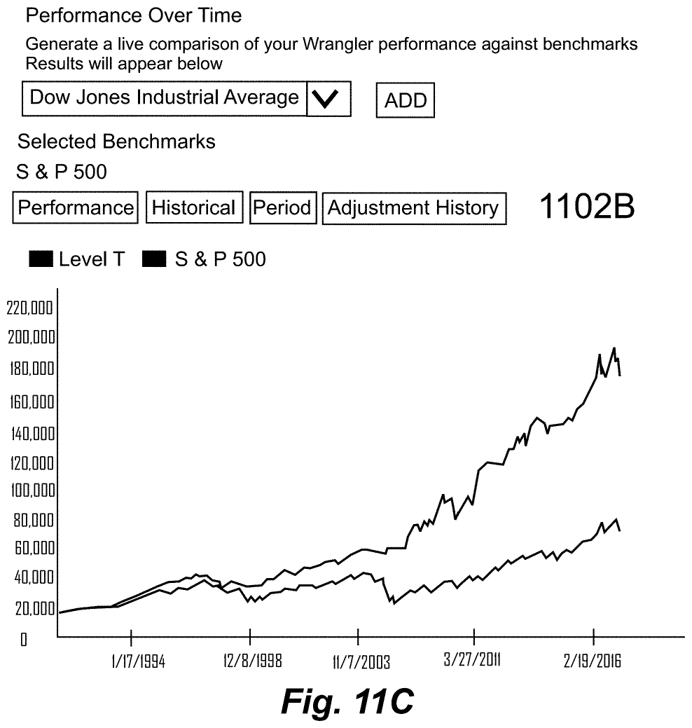

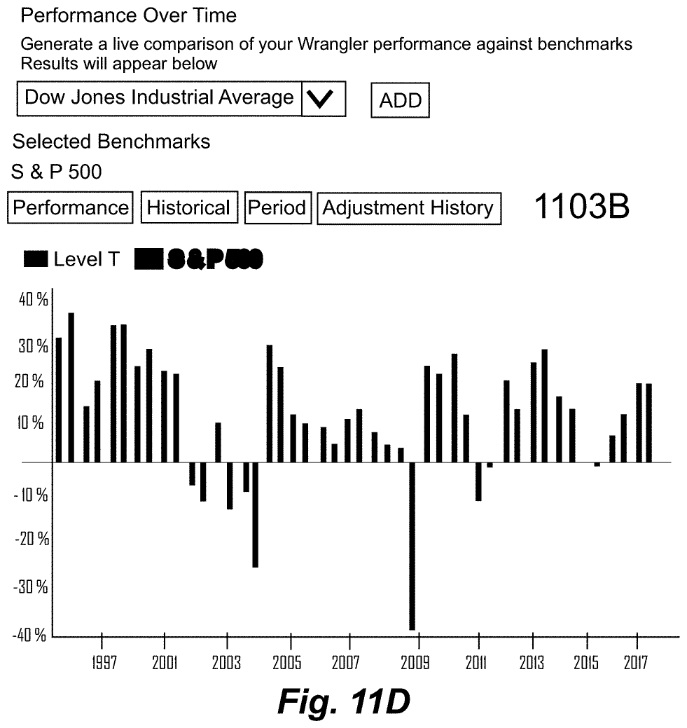

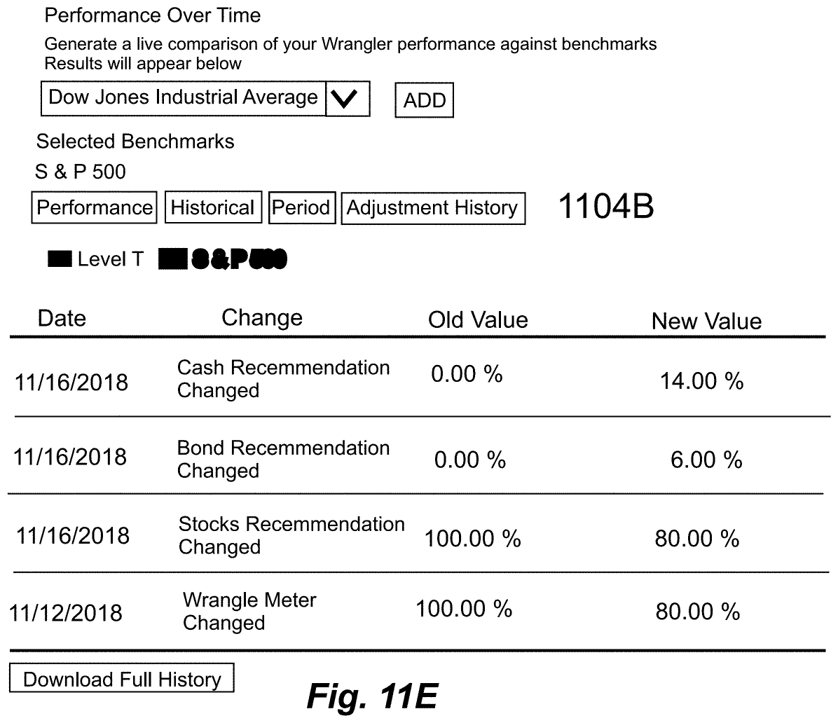

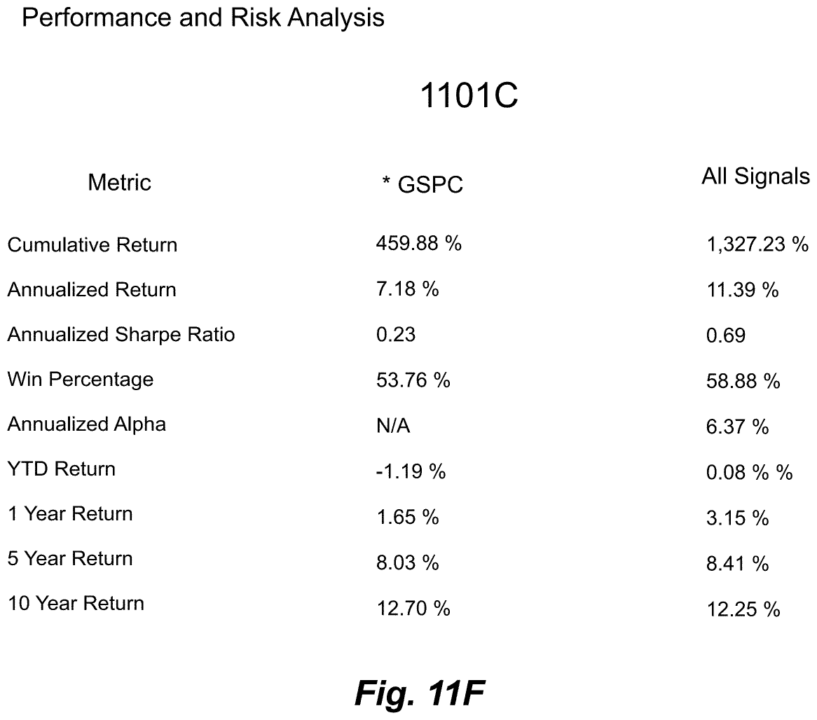

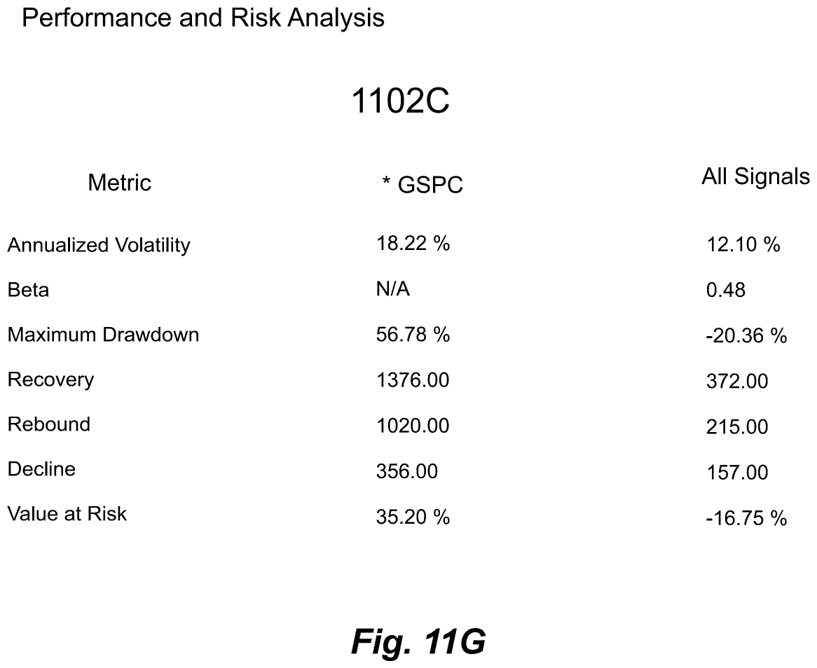

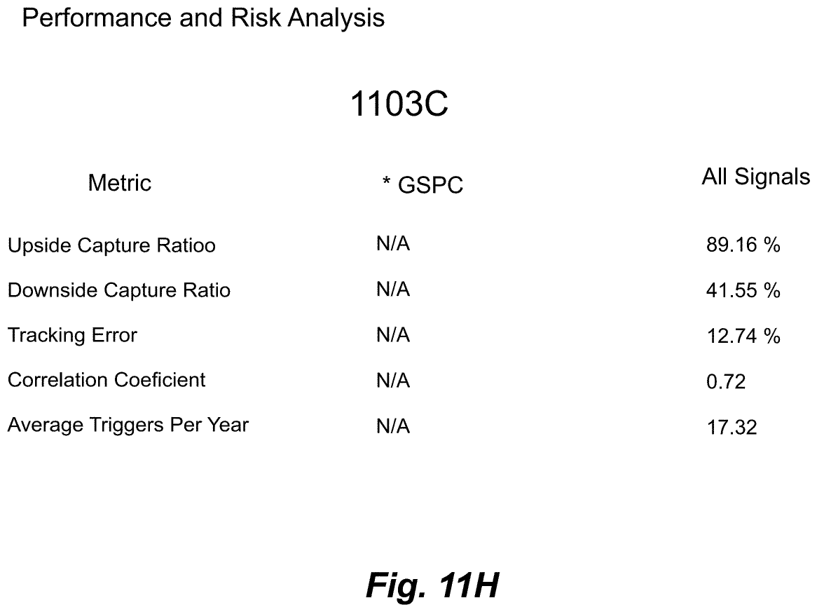

FIG. 11A illustrates a user interface that is a User Dashboard/Overview (Top Section). In this example of the User Dashboard, the inventor has displayed several key elements as the centerpiece for the user's interaction with the system in embodiments of the invention. Wrangler Meter 904 is displayed in top left corner of the User Dashboard illustrated in FIG. 11A and represents the current CAP 701 indication of determination of systematic risk. Again, the output is demonstrated as a proportion of market exposure that is currently optimal. Several quick summary statistics are provided in Account Summary 1101A, which highlights investment performance the User has experienced while interaction with the system in embodiments of the invention.

The current state of the system in an embodiment of the invention provides the user with current investment account value as well as nominal increase in account value over several time periods, including the current month, Year to Date (YTD), and Since Inception of the user's membership to the service. Below Account Summary 1101A are two pie charts. Chart 902 demonstrates the user's Current Allocation and chart 803 displays Recommended Allocation generated for the user. Below Wrangle Meter 904, a Wrangle Recommendation 1104A is illustrated as three spheres providing recommended weights for each asset class. These spheres sit below a more deliberate and verbal instruction that these weights constitute the current Wrangle recommended allocation for the user.

It is important to note that the examples of graphical elements on the User Dashboard in FIG. 11A are only one representation of how the value of the invention can be demonstrated and relayed to the consumer as a service. These depictions are not limiting to the scope of the invention. It should be anticipated that the design and elements instantiated on the User Dashboard may evolve along with the service process of the invention over time.

FIGS. 11B, 11C, 11D and 11E are illustrations of a user interface as a part of the dashboard that provide graphical representations of performance over time for a user's portfolio under different circumstances. In FIG. 11B, also labeled element number 1101B, actual account performance over time is illustrated since the user has joined the service. The user is enabled in the interactive interface to add the performance of a number of broad-based market indices to this graph in order to visually review feasibility of the service (i.e. performance benchmarking). FIG. 11C, also labeled 1102B, illustrates a hypothetical history of the user's account if the user were able to use the service at the inception of the synthesized and back-tested history of the system in an embodiment of the invention. This display is provided to display the potential efficacy of the invention used over a longer time horizon. FIG. 11D, also labeled element 1103B, illustrates this same hypothetical performance as a series of bars representing the annual returns of each respective year along the timeline of the history.

Finally, FIG. 11E, also labeled 1104B, shows historical sequence of Allocation Recommendations 804, Signal changes 405, Wrangle changes 603, and CAP adjustments 701 since the user began using the system in an embodiment of the invention. This file may be exported as a spreadsheet or may be viewed directly in the dashboard. These calculated performance illustrations represent just a few many possible schematics for providing the user with both qualitative and quantitative data from the user's Profile History 901. Again, these are examples, and are not limiting to the scope of the invention.

FIG. 11F illustrates a tab from the dashboard that provides detailed statistics by which a more technically-oriented or professional user may interpret and judge the efficacy of the system. There are three categories of metrics provided, that fall under three separate tabs through which the user may toggle. The first tab is labeled Performance metrics 1101C, where all available return metrics are displayed, including returns over different time periods and several derivations of investment return.

FIG. 11G, also labeled 1102C, illustrates all available risk measurements, including standard volatility metrics and several statistics regarding peak-to-trough drawdown during declining markets. A purpose of this display is to highlight how the system attempts to produce outperformance through an ability to mitigate systematic risk by augmenting CAP 701 (and by extension avoiding declines in the market).

FIG. 11H, also labeled 1103C, is a third tab for statistical demonstration. This tab provides a few additional known barometers by which to measure the relative performance of an investment against a benchmark. All statistics provided are not proprietary to embodiments of the invention. However, they are vital to demonstrating the efficacy and value of the system to the user.

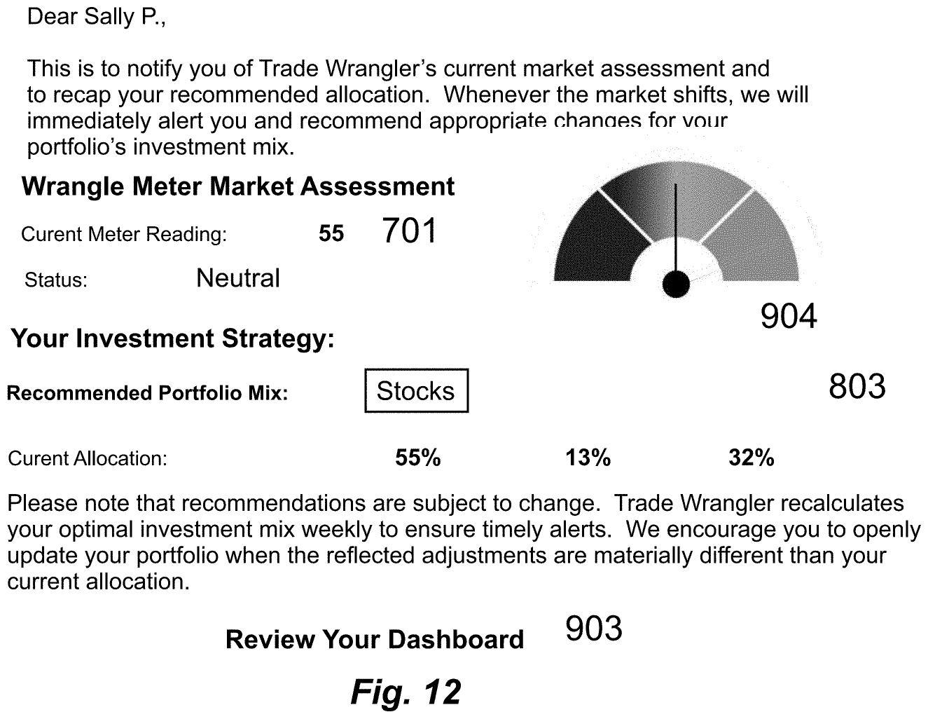

FIG. 12 is an illustration of a user interface provided by the system that demonstrates an example of weekly email alerts the user may receive. As described above the system may provide the user with a series of email and/or text message alerts which can be sent as soon as a material change occurs and on a recurring basis to keep the user abreast of the status of the CAP 701 and the user's current Recommended Allocation 804. In this example, after an introduction message to the user, the email alert addresses the current CAP 701 by providing a numerical value between 0 and 100, the current meter status along with a depiction of the Wrangle Meter 904, and the recommended portfolio mix (or allocation) 803. In an alternative embodiment, the recommended portfolio mix 803 demonstrates the recommended weights of a larger swath of asset classes which include derivations for market capitalization, geography, asset type, and economic development status.

The email alert closes with a disclaimer about the fluctuating nature of the recommendations and the importance of promptly making changes when the service provides such alerts. Finally, below this disclaimer in this example is a link “Review Your Dashboard” back to the User Dashboard 1100 so that the user can review the latest readings and recommendations in further detail. Again, the description of the email alert is not limiting to the scope of the invention, but merely exemplary.

It will be apparent to one with technical skill in the art that the system in various embodiments may be constructed using some, all, or variations of described features and components without departing from the spirit and scope of the present invention. It will also be apparent to the skilled person that the embodiments described above are specific examples of a single broader invention which may have greater scope than any of the singular descriptions brought forth in this document. There may be many alterations made in the descriptions without departing from the spirit and scope of the present invention.

1. A system for assessing market risk and for guiding a user in equity market investing, comprising:
a network connected server;
software executing from a non-transitory medium at the server providing interactive interfaces for a user connected to the server via a browser link; and
a plurality of data repositories coupled to the server;
wherein the interactive interfaces provide a determination of systematic risk as a single factor for aiding the user in making investment decisions, provide more detailed and supportive allocation recommendations that quantitatively account for both systematic and diversifiable risk, and provide timely alerts and instructions to the user based on changes in Market Risk and changes in the user's portfolio performance over time.

2. The system of claim 1 wherein the system constructs a single factor trading algorithm based on market price influences, in real time, determining fluctuations in systematic risk within the market.

3. The system of claim 2 wherein the user is enabled to adjust criteria for assessing systematic risk from a pool of statistically validated factors.

4. The system of claim 1 further comprising diversification instructions that are personally augmented to fit the user's risk profile and time horizon.

5. The system of claim 1 wherein one of the alerts reports changes in a level of systematic risk in the market.

6. The system of claim 1 wherein the system further actively manages the user's investment portfolio and executes portfolio adjustments and investment trades automatically on behalf of the user.

7. The system of claim 1 wherein the system monitors and reports changes in the relationship or correlation of market factors to market prices over time.

8-9. (canceled)
